(19) United States
(12) Patent Application Publication
(10) Pub. No.: US 2011/0051656 A1
(43) Pub. Date: Mar. 3, 2011

(54) DOUBLE RADIO RELAY STATION

(75) Inventors: Serge Hethuin, Colombes (FR); Arnaud Tonnerre, Colombes (FR); Adrien Duprez, Colombes (FR)

(73) Assignee: THALES, NEUILLY SUR SEINE (FR)

(21) Appl. No.: 12/936,223

(22) PCT Filed: Mar. 20, 2009
(86) PCT No.: PCT/EP2009/053311

§ 371 Date: Nov. 22, 2010

(30) Foreign Application Priority Data
Apr. 4, 2008 (FR) 0801869

(51) Int. Cl. H04B 7/14

(52) U.S. Cl. 370/315

(57) ABSTRACT

A relay station used in a communication network that has a tree-structured architecture including a number of hierarchical levels, the communication network including a base station of the highest hierarchical level, one or more relay stations and one or more subscriber stations, wherein a relay station has two radio modules, a first radio module being designed to communicate with stations of lower hierarchical level and a second radio module being designed to communicate with stations of higher hierarchical level, the two radio modules being synchronized in their MAC layer and the relay station including at least one antennas connected to the MAC layer of the radio modules.

The invention relates to a relay station equipped with one or more transmitter-receiver antennas and using two radio modules, based on the same technology, which are coupled together and synchronized at the medium access layer level, better known by the acronym MAC (medium access control).

Setting up relay stations in high capacity communication systems, such as the WiMAX system for example, is a fundamental issue for civil security applications. For example, it is possible to cite suburban surveillance systems or else the surveillance of problem areas. It is also possible to cite defense applications, such as camp protection and zone control. The civil standards are currently trying to provide solutions. For example, the IEEE standardization committee is in the process of specifying this type of mechanisms for mobile WiMAX systems (802.16e) within group 802.16j. The most comprehensive information is available on the Wikipedia site. However, the deployment of this technology will entail a new and comprehensive development of the radio modules currently present in the systems or “chipsets” which may cause technological difficulties and also costs. In the description, the letters RF designate radio frequency and the letters BB, the base band signal.

The subject of the present invention concerns system and hardware architectures (better known by the umbrella term hardware) allowing for the rapid and inexpensive development of relay stations. This new approach is notably based on the coupling of two radio modules within a relay station which are synchronized at the level of the MAC layer. The proposed solution take account of the possibility of deploying directional antennas that can operate in two hierarchical levels (higher and lower), for a communication network deployed in a tree form. This approach is based on the use of inexpensive smart antennas with rapid switching, or FESA (fast electronically steerable antennas). The tree topology consists of a base station of the highest hierarchical level, relay stations RS and subscriber stations SS.

Hereinafter in the description, the letter “n” is used to denote a given hierarchical level in the network tree structure, “n−1” to denote the hierarchical level higher than the level n and “n+1” to denote a hierarchical level lower than the level n. Furthermore, the term “frame” denotes a recurrent time period comprising the different resource allocations for each station. It may also be called “superframe” and is generally delimited by the transmission of synchronization patterns.

The invention relates to a relay station RS used in a communication network that has a tree-structured architecture consisting of a number of hierarchical levels TLi, said communication network comprising a central point, for example a base station BS₀, of the highest hierarchical level, one or more relay stations RSᵢ and one or more subscriber stations SSi, characterized in that a relay station RSₙ has at least two radio modules, a first radio module being designed to communicate with stations of lower hierarchical level TL₍ₙ₊₁₎ and a second radio module being designed to communicate with stations of higher hierarchical level TL₍ₙ₋₁₎, the two radio modules being synchronized in their MAC layer and said relay station comprising at least one antenna connected to said MAC layer of the radio modules. The relaying of the information is implemented at the level of the MAC layer so as to minimize the end-to-end transmission delays.

The invention also relates to the sharing of bandwidth between the different nodes of a network as described previously. In this context, two operating modes are described that provide different frame structures. The multi-channel mode corresponds to the use of a number of frequency channels on the different hierarchical levels attached to the relay station. In the single-channel mode, a relay station operates on the same frequency in the different hierarchical levels that are associated with it.

The invention also relates to a transmission method or protocol implemented within a relay station having at least one of the abovementioned characteristics, characterized in that it uses a smart antenna, said smart antenna using an omnidirectional mode in the periods of the frame in which the relay station transmits in broadcast mode to the lower hierarchical level or in which the relay station receives messages transmitted in a contention period, said messages transmitted in these two periods of the frame using a robust modulation (such as QPSK) whereas the other transmission slots use modulations designed to offer a higher bit rate.

The invention also relates to a method executed within an abovementioned relay station, characterized in that it uses a smart antenna and in that it comprises a step during which the changes of direction of the beam from the smart antenna, enabling the directions of arrival of the messages at a given moment to be assessed, occur in a period of the frame dedicated to the procedures used to assess the distance between two stations of different hierarchical levels and associated so-called “ranging” transmission powers by the exchange of existing “ranging” messages and measurement of the received signal strength and/or the packet error ratio.

Other features and advantages of the device according to the invention will become more apparent from reading the following description of an exemplary embodiment given in an illustrative and nonlimiting manner, with appended figures which represent:

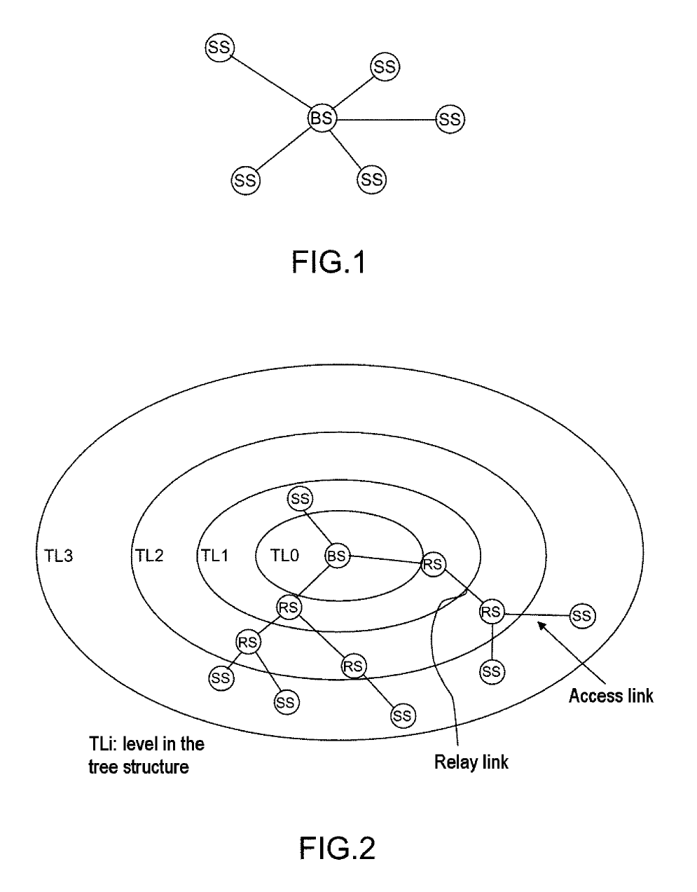

FIG. 1, an exemplary point-multipoint network topology,

FIG. 2, an exemplary four-level tree topology,

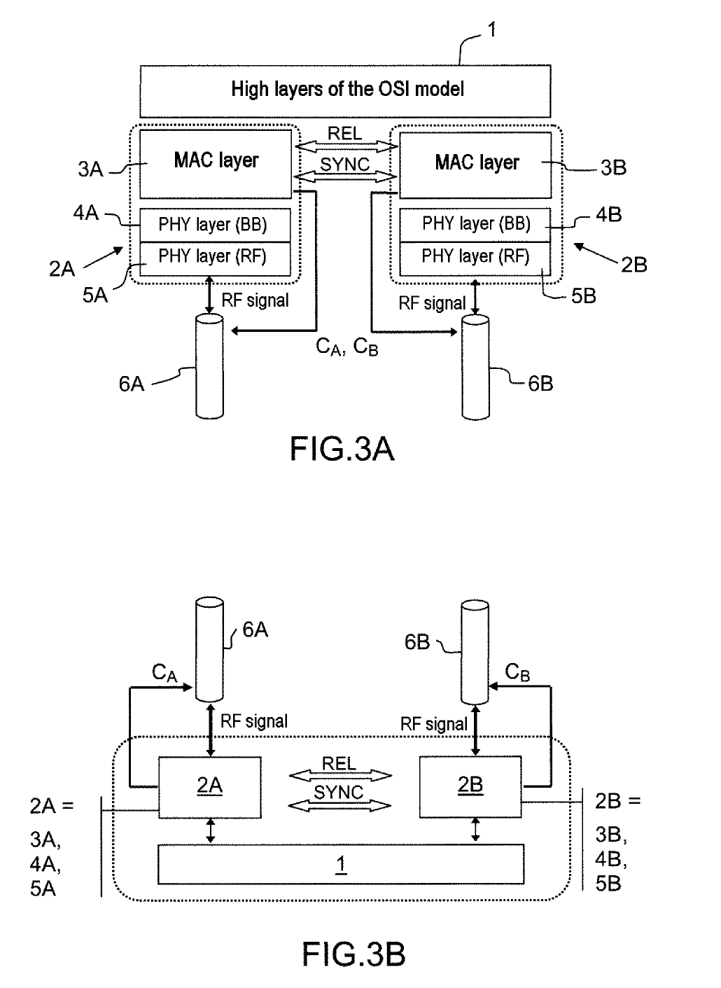

FIG. 3A and FIG. 3B, a first exemplary functional scheme and the architecture associated with a relay station according to the invention,

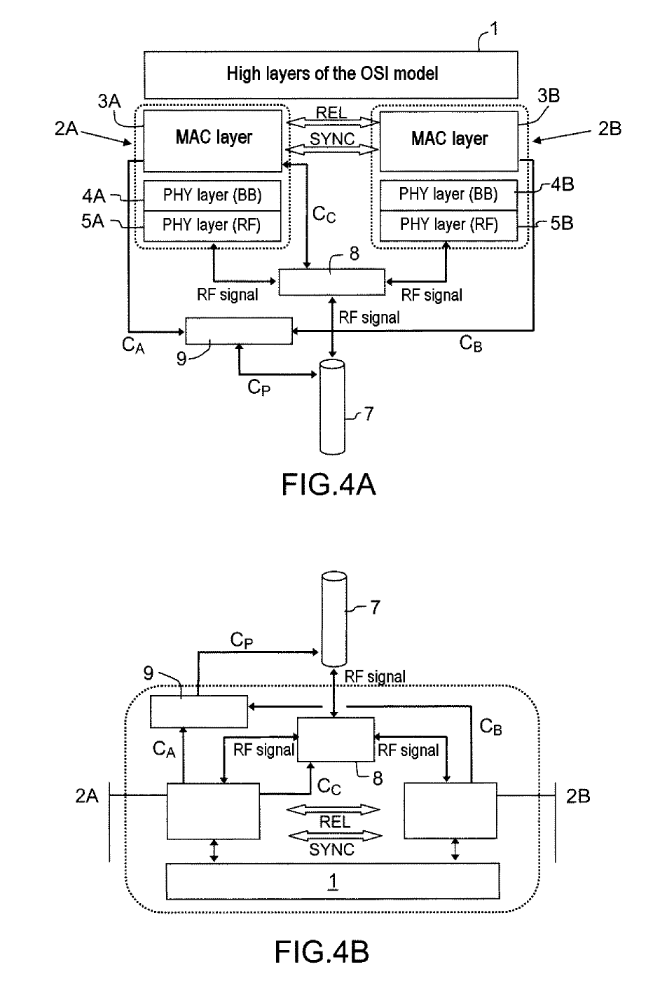

FIGS. 4A and 4B, a second exemplary functional scheme and an architecture of a relay station according to the invention,

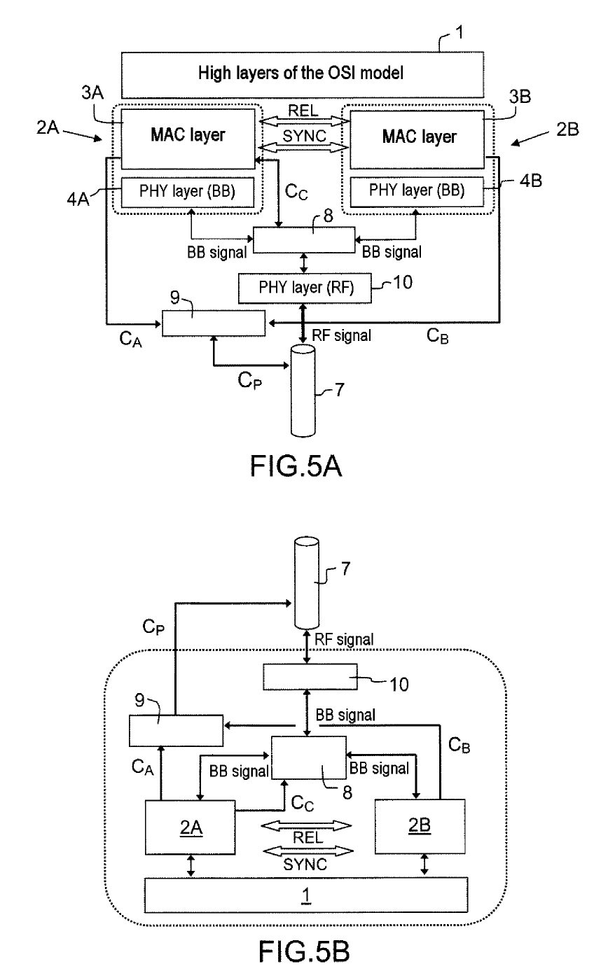

FIGS. 5A and 5B, a third exemplary functional scheme and a third exemplary relay architecture according to the invention,

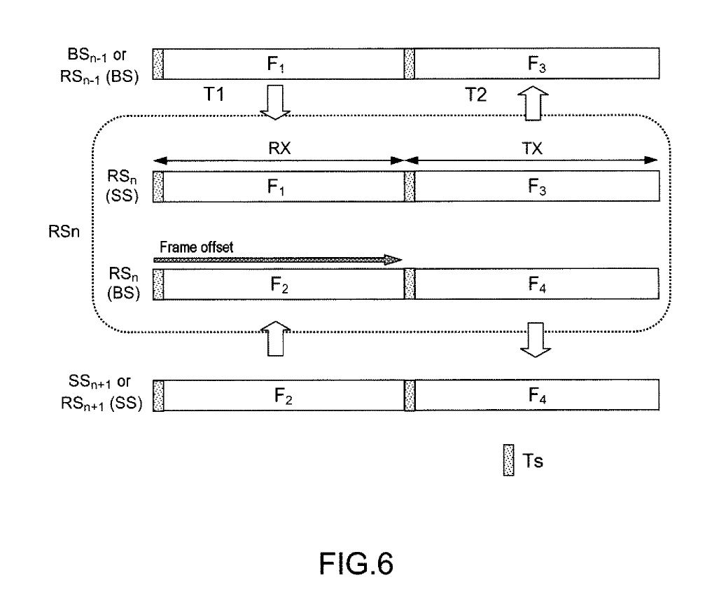

FIG. 6, an exemplary frame structure used in the case of multi-channel mode operation,

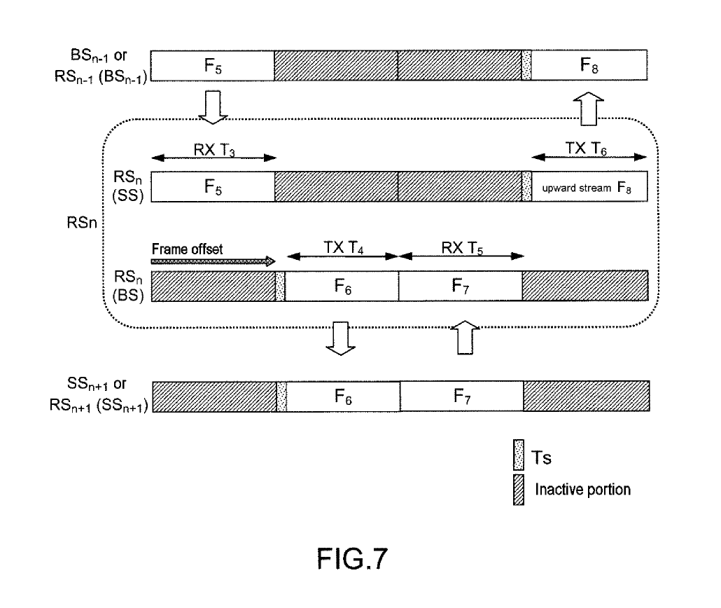

FIG. 7, an exemplary frame structure used for single-channel mode operation,

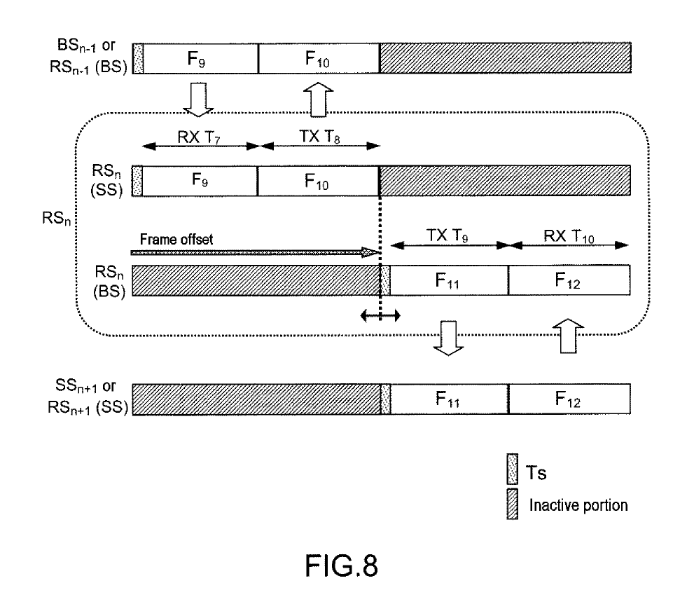

FIG. 8, a second exemplary frame structure used for single-channel mode operation,

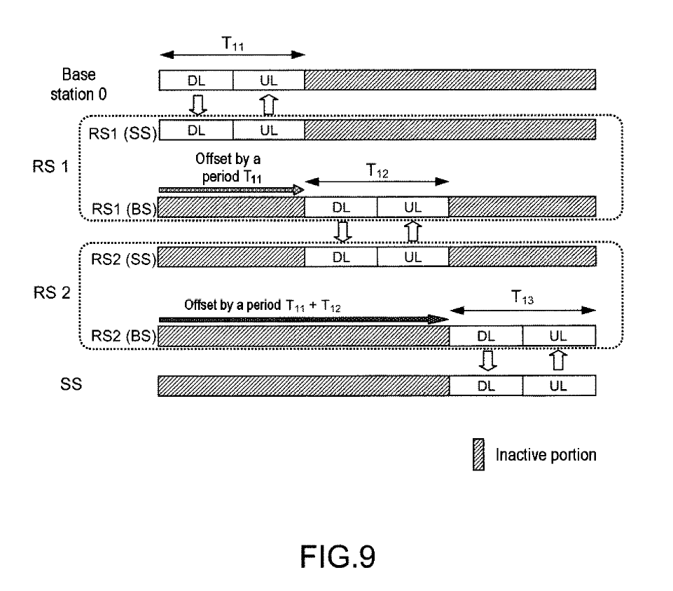

FIG. 9A, an exemplary frame structure in a multiple-level tree in single-channel mode,

FIG. 9B, another exemplary frame structure in a branch of the multiple-level tree with spatial reuse,

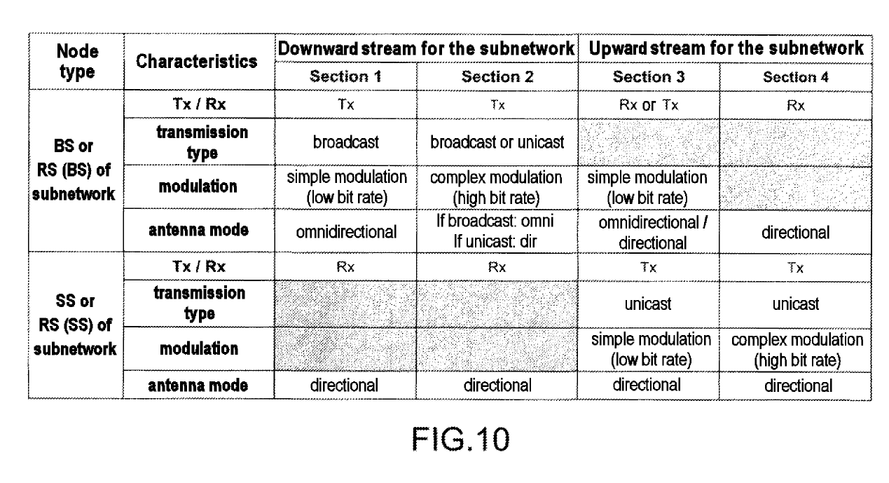

FIG. 10, a table combining transmission characteristics for a given configuration,

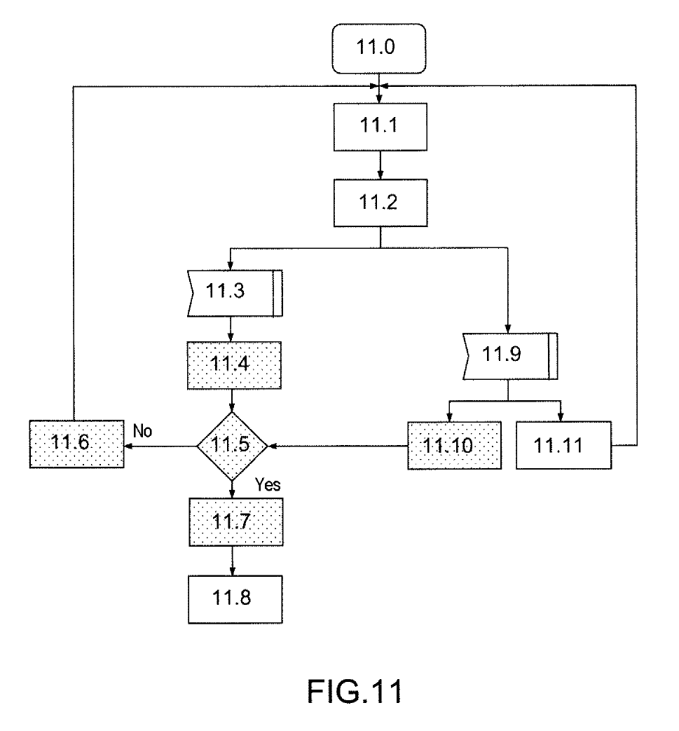

FIG. 11, the steps implemented during the network entry procedure for a station,

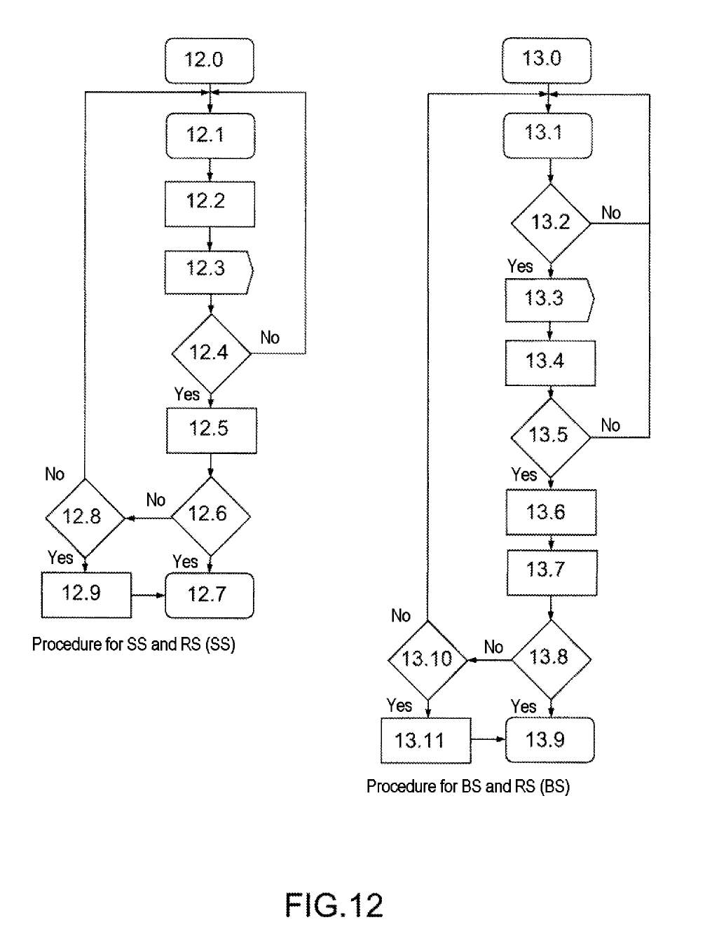

FIG. 12, the steps executed during the tracking procedures, and

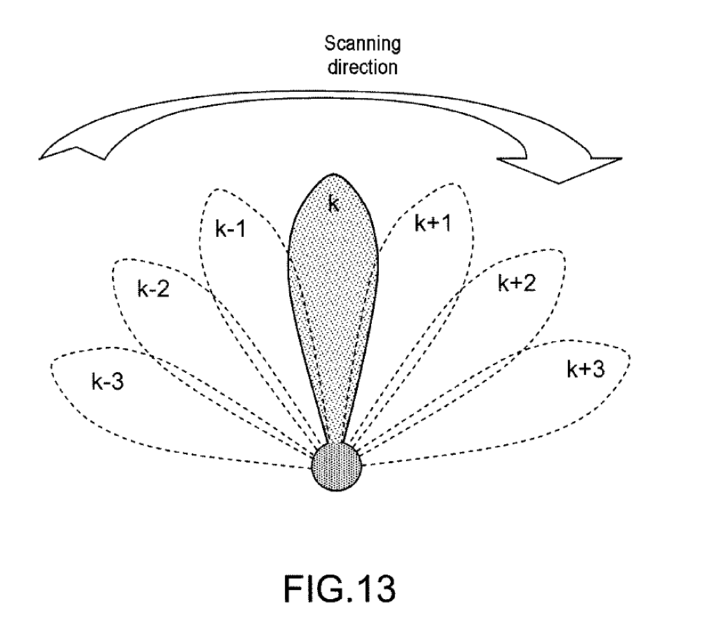

FIG. 13, a diagram representing the scanning direction of an antenna.

In order to make it easier to understand the architecture and the operation of the relay stations according to the invention, the example in the description uses an FESA-type smart antenna in an 802.16d and 802.16e context, for example.

Without departing from the framework of the invention, the latter may also be applied to omnidirectional antennas. The use of FESA smart antennas makes it possible notably to obtain a better gain and a better speed in changes of direction of the pointing angle. The description will also target, as an example, the WiMAX context, within a system comprising one or more base stations (BS), and also relay stations (RS) and subscriber stations (SS).

FIG. 1 shows an exemplary architecture of a point-multipoint system comprising a base station BS communicating with a number of subscriber stations SS which are distributed in star form. Such a structure offers limited coverage and also limited connections.

FIG. 2 represents an architecture which implements a number of relay stations RS. This architecture corresponds to a tree topology in which the relay stations RS communicate with the base station BS of the system and also with the subscriber stations SS. The network has a tree structure which consists of a number of hierarchical levels denoted by the letters TLᵢ in which i denotes a level of hierarchy in the network. A relay station RS notably has the capacity to relay the information streams circulating on the uplink (toward a base station, the main base station of the network or else the radio module having the role of a base station of a relay station). It also has the capacity to relay the information streams circulating over the downlink (base station to relay station or relay station to subscriber station SS).

An access zone represents all the links that exist between a subscriber station SS and a relay station RS, or between a subscriber station SS and the base station. A relay zone relates to the links, called relay links, which link two relay stations RS or else a relay station RS and the base station BS. For example, the point-multipoint topology consists exclusively of access links. The relaying mode according to the invention is a so-called “non-transparent” relaying mode, in which all the packets, including the signaling, are transmitted by the relay stations RS. The architecture in which the invention is implemented comprises, notably, a base station BS and a number of subscriber stations SS which can be connected to this base station BS by using one or more relay stations RS. The network has, for example, the form of an abovementioned tree with different levels TL₀, TL₁, etc, in which lowest index i corresponds to the highest hierarchical level. A relay station RS can be implemented to operate with at least one of the following two modes: a first, single-channel mode (in which a single frequency is used by the RS) and a second, multi-channel mode (the RS uses two different frequencies for the communications implemented in the two different hierarchical levels). The two operating modes require the presence of two radio modules to operate, one radio module being able to be seen as a subscriber station capable of communicating with a BS or a higher level RS, and one radio module corresponding to a base station, able to communicate with an SS or an RS of lower hierarchical level.

If we consider a relay station RS comprising two radio modules according to the invention, the network topology based on the tree can be divided into a number of subnetworks, each subnetwork consisting of a radio operating as a base station BS of a hierarchical level TLₙ associated with one or more radio modules comparable to a subscriber station SS of lower level TLₙ₊₁. Such subnetworks correspond to point-to-multipoint topologies interconnected by relay stations.

Three exemplary architectures for a relay station according to the invention are given to illustrate the principle implemented by the invention. The examples are given by using a smart antenna of FESA type. These antennas are controlled by the MAC layer of the WiMAX station in real time so as to control the system with a very low switching time. The objective is to change the beam direction after each transmission of packets in order to allow point-to-multipoint communications. Without departing from the context of the invention, it is also possible to use any type of antenna including a transmission function and a reception function. Several exemplary architectures will be detailed in order to better convey how a relay station according to the invention operates.

FIG. 3A is a first functional diagram for a relay station according to the invention.

A relay station according to the invention comprises, for example, a motherboard 1 comprising the top layers of the OSI model, and two radio modules 2A, 2B. Each radio module 2A, 2B comprises a medium access layer MAC (medium access control) 3A, 3B, a base band physical layer, 4A, 4B, a radio frequency RF physical layer 5A, 5B. The physical layers 5A, 5B receive the radio frequency signal from antennas 6A, 6B or can be used to transmit a radio frequency RF signal. The antenna 6A, 6B is, in this exemplary embodiment, a smart antenna of FESA type. However, any type of smart or omnidirectional antenna can be used instead of the FESA antenna.

A relay station RS can be seen as a station comprising a first radio module 2A (3A, 4A, 5A) and a second radio module 2B (3B, 4B, 5B), the two modules being mutually synchronized. The first module is dedicated, for example, to communication with the stations of higher hierarchical level and the second module is dedicated to communication with the stations of lower hierarchical level.

One of the radio modules of the relay, for example the module 2A comprising the MAC layer 3A, the base band physical layer 4A and the radio frequency physical layer 5A, combines the bottom layers dedicated to communication with the stations of lower hierarchical level.

FIG. 3B represents an exemplary architecture or physical implementation corresponding to the functional scheme represented in FIG. 3A. The same numbers are used to designate the elements or modules that constitute the relay station, described by their functionality in FIG. 3A.

FIG. 3A also shows: the relayed information streams REL which relate to the MAC layers 3A, 3B; the synchronization control SYNC between the MAC layers 3A, 3B of the radio modules of the relay according to the invention; the commands C_{A} and C_{B} for the antennas, managed by an MAC layer.

FIGS. 4A and 4B represent a variant embodiment of the relay station, which comprises a single transmission-reception antenna 7, a first switch 8 through which the radio frequency RF signals transmitted or originating from the antenna 7 pass, the switch 8 being controlled by a command C_{C} originating from, for example, the MAC layer 3A dedicated to communication with the stations of higher hierarchical level. In practice, one of the two radios of the Relay Station acts as master. This so-called master radio could be, for example, the SS part because it is this part that receives the synchronization pattern from the higher hierarchical level and that can therefore synchronize the other part on the higher level. More specifically, with regard to the control of the switch C_{C}, the two parts know the structure of the frame and consequently know exactly when the switchovers must occur. It is therefore simpler for a single element, the so-called master radio, to manage switchovers. A second switch 9 is used to convey commands originating from the MAC layers 3A and 3B (command C_{A} and C_{B}) and intended for the antenna 7. The command C_{P} corresponds to the juxtaposition of the commands C_{A} and C_{B} and is used to control the direction of the main lobe of the antenna 7. The elements that are identical to those of FIGS. 3A and 3B are given the same references. The switch 8 receives, for example from the MAC layer 3A, a control command CTRL whose function is notably to select the radio module that has to operate according to the uplink or downlink communication.

The synchronization SYNC and relaying REL are still executed at the level of the MAC layers 3A, 3B. The relay of data, control and management packets is performed, for example, at level two of the OSI protocol stack by establishing a link between the two MAC layers of the two radio modules of this same station.

FIGS. 5A and 5B represent a variant embodiment of a relay station in which the radio frequency physical layer 10 is common to both radio modules and is positioned between the switch 8 and the antenna 7. In this case, the base band signal transmitted by one of the physical layers passes through a switch 8 before being transmitted to a radio frequency physical layer 10 which communicates with the antenna 7. The control command C_{C} for the switch 8 is transmitted by the MAC layer 3A for example. The synchronization signals SYNC and the relay data REL are exchanged between the MAC layers 3A, 3B of the relay according to the invention. The antenna command C_{P} is deduced from the antenna commands C_{A} and C_{B} via the switch 9. The command C_{C} from one MAC layer is used notably to choose the radio module that is active according to the communication at a given instant.

FIG. 6 diagrammatically represents a frame structure that can operate in a multi-channel transmission context (relay station in multi-channel mode). In this mode, two radios can operate simultaneously because they use different frequencies. However, it is necessary to take into account the interferences (notably co-site) between adjacent channels because a transmission transmitted on one frequency can cause interferences on one of the adjacent channels. To resolve this problem, the frame structure for the multi-channel mode is constructed on the following principle; when one of the two radios of the relay station receives, the second radio must not transmit. In this case, the two radios should be in the same state, either transmitting or receiving. In this frame structure, the start of the frame from one of the radios is offset to make the TX and RX periods coincide, and upon each change of hierarchical level the radio that performs the offset must be modified.

The indices n, n−1, n+1 are used to denote the different levels at which the relay stations are located and corresponding to the indices of the levels TLᵢ in the network tree structure. In the examples described in FIGS. 6, 7 and 8, the level TLₙ is chosen to denote a relay station which communicates with a base station of higher level TLₙ₋₁, assuming the hierarchical tree of FIG. 2, and also with a station of lower level, or level TLₙ₊₁.

The frame structure from a relay station of level n, RSₙ, is broken down into two parts corresponding to a reception period (RX period) and a transmission period (TX period).
In the RX period, corresponding to the time slot T₁, the “subscriber station” part RSₙ (SS) of the relay station receives the data F₁ transmitted by the base station BSₙ₋₁ or by a relay station RSₙ₋₁ of higher level (downward stream). Furthermore, the “base station” part RSₙ (BS) of this relay station receives streams F₂ originating from one or more subscriber stations SSₙ₊₁ or relay stations RSₙ₊₁ of lower hierarchical level (upward stream).
In the TX period, corresponding to the time slot T₂, the “subscriber station” part RSₙ (SS) of the relay station transmits data F₃ to BSₙ₋₁ or RSₙ₋₁ of higher level (up stream), and the “base station” part RSₙ (BS) of this relay station transmits data F₄ to one or more SSₙ₊₁ or RSₙ₊₁ of lower hierarchical level n+1 (down stream).

The base station BS and the “base station” part of the relay stations RS act as master in the subnetwork that is associated with them (formed with the stations of lower hierarchical level). They transmit a synchronization pattern (not represented, in order to keep the figures simple) to their nodes of the slave network in order to synchronize the frames in time. Also, the overall synchronization of the network is obtained by a synchronization (at the MAC layer level) of the two parts of the relay station; RS (SS) and RS (BS). It can be done by sending a synchronization pattern from the RS (SS) part to the RS (BS) part within a relay station at the start of one of the periods (RX or TX). In practice, in a centralized architecture, all the nodes of the network are synchronized on the base station (central point). The synchronization is therefore done in successive hops working from the top level to the bottom level. This is why the RS (SS) sends the synchronization pattern to the RS (BS), which amounts to synchronizing the lower hierarchical level on the higher level.

Throughout the system, the various subnetworks (a BS or RS (BS) associated with one or more SS or RS (SS)) must use different channels in order to avoid interferences between subnetworks. It is possible to implement space reuse mechanisms in particular by virtue of the directivity provided by smart antennas, which are known to those skilled in the art and will not therefore be detailed.

FIG. 7 diagrammatically represents another frame structure that can be used, this time in a single-channel transmission context (relay station in single-channel mode). The notations of FIG. 6 are used again for the corresponding elements or modules.

When the depth of the tree is limited to two hops (that is to say, a branch of the tree can contain only one relay station), the frames are divided into 4 parts, symbolically represented by the periods T₃, T₄, T₅ and T₆ in FIG. 7. It should be noted that, in a relay station, the start of the frame of lower hierarchical level is offset so as to make the end of the period T₃ correspond with the start of the period T₄. With these notations, the method proceeds as follows: in the first period RX (time slot T₃), the SS part of the relay station RSₙ receives information or a data stream F₅ from the base station BSₙ₋₁ or from the relay station RSₙ₋₁ of higher level, and during this time, the RSₙ (BS) part of the relay station is idle.

Then, in the first period TX, corresponding to the time slot T₄, the RSₙ (BS) part of the relay station will transmit information or a data stream F₆ to one or more subscriber stations or RSₙ₊₁. Then, a TX/RX switchover enables the same part, RSₙ (BS), to receive data F₇ transmitted from the lower hierarchical level n+1. Finally, in the second period TX, time slot T₆, the RSₙ (SS) part of RS can transmit information F₈ to the base station of higher level n−1.

The synchronization between the two radio modules can be obtained by transmitting a synchronization pattern from the RSₙ (SS) part to the RSₙ (BS) part at the end of the first RX period, corresponding, for example, to the start of an 802.16 frame (transmission of the preamble) in the WiMAX context.

In the above case, if a number of relay stations of the same hierarchical level coexist in the network, then it is necessary to accurately manage the allocations for each RS in the TX periods (T₄ and T₆).

When the depth of the tree is greater than two hops (that is to say, if a branch of the tree can have more than one relay station), a “multiframe” structure is implemented. In this case, two subnetworks comprising consecutive hierarchical levels use the same frame, so an additional frame is used for two other subnetworks using lower hierarchical levels. For example, in a branch of the network that has 3 relay stations, the subnetworks BS₀/RS₁ (SS) and RS₁ (BS)/RS₂ (SS) use the frame t whereas the subnetworks RS₂ (BS)/RS₃ (SS) and RS₃ (BS)/SS₄ use the frame t+1.

This procedural method is advantageous in the case where a branch of the tree has a maximum of one relay station, that is to say, in the case where the depth of the tree is less than or equal to 2 hops. The benefit of such an approach relates to the location of each of the portions in the frame, which allows for the efficient relaying of the information.

FIG. 8 shows a different organization of the frame compared to FIG. 7, the objective being to simplify the development of the relay station. In this case, the frame structures used for the different subnetworks are the same, in fact they are simply offset so as to avoid the interferences between subnetworks.

In a simple network comprising simply one relay station, and using some of the notation of the preceding FIGS. 6 and 7, the method according to the invention proceeds as follows: in the first RX period, time slot T₇, the RSₙ (SS) part of the relay station receives information or a data stream F₉ from the base or relay station of higher level, and during this time, the RSₙ (BS) part of the relay station is idle. Then, in the first TX period, time slot T₈, it is still the RSₙ (SS) part of the relay station that is operating. However, this time it will transmit information F₁₀ to the station of higher level. Then, this part of the RS is idle, whereas the subscriber station part is active. Firstly it can transmit, to the lower level, streams F₁₁ in the period T₉, and then receive, in the period T₁₀, streams F₁₂ also originating from the lower level.

The synchronization between the two stations can be obtained by transmitting a synchronization pattern from the SS part to the BS part of the relay station at the end of the period T₈, corresponding, for example, to the start of an 802.16 frame (transmission of the preamble) in the WiMAX context.

This solution allows for a simpler hardware implementation. This organization can be extended to networks that use several relay stations (number of subnetworks greater than two), simply by allocating an RX period and a TX period that are consecutive to each subnetwork. Thus, the incorporation of a new subnetwork in the system entails reducing the bandwidth for each subnetwork that is already associated (without spatial reuse mechanism), and the allocation of two communication periods (RX and TX) dedicated to this subnetwork. This allocation must be offset relative to the other allocations in order to avoid the interferences between subnetworks. FIG. 9A shows an exemplary frame structure in which the network comprises two relay stations.

It should be noted that it is possible to have a new cycle start between BS₀, and RS₁(SS) in parallel with the exchange between RS₂(BS) and SS. In fact, it is possible to limit the loss in bit rate, regardless of the number of levels of the tree in a branch, to a factor two, due to the initialization of the transmission pipeline. This is illustrated in FIG. 9B in which the simultaneous exchanges between BS and RS₁(SS), one the one hand, between RS₂(BS) and RS₃(SS), and between RS₄(BS) and SS, on the other hand, and therefore more generally simultaneous exchanges between BS of level n with SS of level n+1, BS of level n+2 with SS of level n+3, and so on, in a spatial reuse context, can be seen.

The arrows F correspond to the information streams exchanged between the stations of different hierarchical levels. The shaded arrows correspond to the start of a new period as in FIG. 9A.

The allocation management algorithms are based on identifiers assigned to the base station and to each relay station. The base station is always associated with the identifier 0, and each relay station is attached to an identifier that is assigned to it according to its placement in the tree topology, more specifically, it is linked to the hierarchical level (TLᵢ), the aim being that a station of hierarchical level n has an identifier greater than the stations of higher level (n−x) and an identifier lower than the stations of lower hierarchical level (n+x), x being the number of levels separating the stations. The invention provides two allocation management modes: a static mode and a dynamic mode.

For the static mode, a simple algorithm can be implemented to manage the allocations made in the frame. The relay stations that have to be deployed are known initially and their identifiers are assigned when they are configured. Each base station and relay station has the same bandwidth which corresponds to the division of the resources available by the number of relay stations, incremented by one unit. An exemplary frame structure is shown in FIG. 9, in which the periods T₁₁, T₁₂ and T₁₃ would be equal to a period T. The base station and the “base station” parts of each RS determine the start of their period by being based on the identifier allocated to the node. Thus, the offset relative to the start of the frame for a BS or RS (BS) station having the identifier y corresponds to the multiplication of this identifier by the period T. Consequently, the base station of the network always begins at the start of the frame. This algorithm can be used when the base station and the relay stations are fixed.

The dynamic mode is used to take account of the topology modifications that can occur when the network is operating, in the management of the system resources. Firstly, when a relay station is started up, the “subscriber station” part scans the predefined channel and tries to be associated with the station whose synchronization pattern (preamble, beacon, etc) corresponds to the best signal quality. The association procedure consists, for example, of a synchronization and an exchange of data including the resource allocation information intended for the BS part of this same relay station, the start of the allocation and the duration of this allocation.

When the association is performed with the station of higher hierarchical level, RSₙ(SS) can transmit a synchronization pattern Ts to the “base station” part RSₙ(BS) of this same relay station at the end of the first RX period. This synchronization pattern is transmitted at the time corresponding to the start of allocation granted to the RSₙ(BS) part and must also contain information such as, for example, the duration of the allocation period for the subnetwork managed by this RS (BS). From a general viewpoint, it is the network's base station that determines the allocations according to requests transmitted by the various relay stations. For this, messages are transmitted periodically (with a predetermined period) by all the relay stations to the base station. More specifically, the “base station” parts of each RS assess their bandwidth requirement and transmit this information to the corresponding “subscriber station” part accompanied with complementary information such as, for example, a priority rating. All this information is then transmitted to the BS in the periodic message. If the BS does not receive a certain number of consecutive messages originating from an RS, then it considers the latter to be disassociated.

The identifiers can be modified when a relay station enters into the network or leaves it (failures, unfavorable environment, etc). In this case, the base station informs all the RSs of the network so that they can take account of a possible change to their identifier.

From a general viewpoint, if the relay station is not directly linked to the base station of the network, then the information exchanged between these two nodes must be relayed by the intermediate RS or RSs. The data from stations of lower levels can be merged by a relay station in one and the same message intended for the BS.

In the various examples described hereinabove, any type of antenna can be used.

The benefit of using smart antennas, for example FESA antennas, in a network having a tree-type architecture, is that they significantly increase the capabilities of the system, notably with regard to coverage. In practice, the FESA antennas offer a directional and concurrent beam capability, their use allows scanning over 360° by exploiting the rapid switching of the antenna beam. This antenna is capable of operating in two modes:
Omnidirectional mode in which the antenna transmits a beam in all directions at the same time. The antenna gain is weaker than in the case of the second mode, which means reducing the range of the node associated with the antenna.
Directional mode, which relates to the selection of an antenna beam for communication in a given direction.

In the case of a tree network architecture in which the relay stations may be equipped with smart antennas, for example of FESA type, three link configurations may be encountered:
the “omnidirectional to omnidirectional” link configuration (OvO) in which no node is equipped with directional or smart antennas,
the “omnidirectional to directional” link configuration (OvD), in which one of the two neighboring nodes uses an omnidirectional antenna whereas the other station is equipped with a smart antenna (FESA for example),
the “directional to directional” link configuration (DvD) in which two neighboring nodes are equipped with smart antennas.

To enable the method according to the invention to be implemented in relay stations equipped with smart antennas in a network that has a tree architecture, various search procedures are required.

The so-called “blind” procedures are required for networks in which the stations do not know the coordinates of their near neighbors. The relay stations RS and/or the subscriber stations SS are roaming or mobile, there is no common reference direction throughout the network. The following descriptions are concentrated on the blind antenna control procedures.

When a base station or the “base station” part of a relay station uses an omnidirectional antenna, only the two configurations OvO and OvD can be envisaged in the associated subnetwork and, in this case, the neighbor discovery procedures (if one of the SS or RS (SS) of the subnetwork is equipped with a smart antenna) do not result in specific adaptation of the transmission modes in the frame.

However, the use of a smart antenna in a base station or a relay station increases the complexity of the neighbor discovery procedures. The solution proposed in this invention is based on particular combinations between the modulation used for the transmission and the mode of the smart antennas. Thus, the frame structures presented previously may be divided into four sections, two sections for the up period and the two sections for the down period.
Section 1 relates to the transmission of the synchronization pattern and to the data intended for all the subnetwork, and it is included in the down period. For example, for a WiMAX system, it corresponds to the sending of the preamble, of the control header or FCH (frame control header) and the first time slot for the downlink which are broadcast by the base station or the “base station” part of a relay station. In this section, the messages are transmitted with a simple modulation, such as BPSK or QPSK, which corresponds to a low bit rate. In this section, the base station of the subnetwork must use the omnidirectional mode of the smart antenna, whereas the receiving antennas must operate in directional mode so as to maintain a given or nominal coverage.
Section 2 combines all the other slots of the period associated with the downlink. The data transmitted in these slots may be either broadcast in broadcast or multicast mode, and in this case the base station of the subnetwork must adopt the same operation as in section 1. Otherwise, when the data are transmitted in “unicast” mode, the transmissions may use high bit rates with a directional antenna mode at the BS or the RS (BS) level.
Section 3 is associated with the contention periods that are used in the period corresponding to the uplink to enable, for example, the SSs and RS (SS)s to be associated with their higher level station. In this section, the base station or “subscriber station” part of the relay station is not up to date with the transmissions that are implemented by the various subscriber stations, so it must operate in an omnidirectional mode so as to be capable of receiving control messages coming from different SSs or RS (SS)s. These messages must be transmitted with a simple modulation, corresponding to a minimal bit rate.
Section 4 combines all the other uplink slots, which are always in “unicast” transmission mode with antennas that can operate in directional mode on the two hierarchical levels and with a complex modulation, such as, for example, QAM 64 modulation, providing high bit rates.

The characteristics of each of the sections are grouped together in the table of FIG. 10.

The network entry procedure for a relay station or a subscriber station has been described previously; it comprises the search for the station of higher level that provides the best characteristics (number of hops to the BS, received signal quality, etc), the synchronization with this station and the association procedure. During the first phase (scanning phase), a station equipped with smart antennas wishing to enter into the network must scan the various available channels and also test all the positions of the beam in a “round robin” manner. Consequently, the scanning duration Tscan relates to the number of channels available Nchannels and to the number of beams Nbeams that can be used by the smart antenna. This scanning procedure is detailed in FIG. 11 which diagrammatically represents the various steps implemented during the network entry procedure for a station. To sum up, the steps of this procedure comprise the following steps:

step 11.0: start of algorithm
step 11.1: start of a time counter or timer
step 11.2: search for a synchronization pattern on a transmission channel i, or for a frame
step 11.3: if this pattern or frame is detected, then:

11.4: store the measurements made or metrics

11.5: check to see if all the lobes of the antenna have been tested (has the antenna finished scanning?)

11.7: if yes, then select the beam and perform synchronization, step 11.8

11.6: if no, change beam, change channel and return to step 11.1

step 11.9: in the case where the pattern is not detected (time period exceeded or time out), then

11.10: if all the channels have already been tested then go to step 11.5

11.11: if there are no more channels available then scan channel i+1 and return to step 11.1.

The WiMAX systems support procedures allowing for the entry and registration of a new subscriber station in the network. The overall initialization procedure can be divided into a number of phases, including the scanning of the channel for the downlink, synchronization, a procedure used to make measurements on the radio channel (better known by the term “ranging”), negotiation for basic capabilities and connection configuration.

For the scanning step, the algorithm is initialized 11.0 and a timer is initialized 11.1.

During the scanning step, the subscriber station or the SS part of a relay station RS scans the channels and the available beam positions, for example according to a procedure in which the measurements are made one after the other in a predefined order, or via a so-called “round robin” procedure. Thus, the scanning duration Tscan relates to the number of channels available Nchannels and to the number of beams that can be used by the antenna Nbeams.

When a base station or a relay station (BS part) is operating, it must broadcast the preamble, FCH, and the first slot DL in an omnidirectional mode in order for each station of lower hierarchical level to be able to receive this information. Thus, the scanning procedure for a node equipped with a smart antenna consists in searching for the preamble of the frame start transmitted by the station of higher level, step 11.2.

With regard to the subscriber stations or the SS part of the relay stations, a beam from the smart antenna is selected randomly so as to start initialization. Measurements are made for each beam and the sweep time of an antenna beam depends specifically on the scanning time, or “scan timer”, called T20 in the IEEE 802.16-2004 procedure, which corresponds to a duration of 2*Tframe. The assessment time can be determined as follows if the time associated with the timer T20 is sufficient to obtain the received signal strength and error rate measurements: Tscan=(2*Tframe)NchannelsNbeams.

During each scan, the modem of the communication system may store the measurements made in order to offer different metrics with which to select the available beam for the operation. These metrics are, for example, divided into two measurement subgroups, the first group relating to the signal strength metric “SSM” and the second group relating to the signal quality metric “SQM”. In addition to these metrics, the CPU may also store different parameters associated with each measurement such as the orientation of the beam and the address of the associated station. By comparing the various SSM and SQM values, the receiving module can determine the best orientation of the beam for the incoming signal. Once the beam is selected, the procedure requires no modification compared to the algorithm for the synchronization of a conventional point-multipoint (PMP) WiMAX system until the node is synchronized. Also, if the station is a relay station, it will then start the transmission of the messages for the downlinks (preamble, FCH and first downburst) to the lower hierarchical level. This operation is executed according to the structure of the frame envisaged for the relay station.

Mobility management in the proposed system is handled as follows.

A set of measurements are performed continuously and stored each time packets are received in all the stations. They are based on the abovementioned two metrics: the strength of the signal and the quality of the signal. The average values of these two values are calculated over a number of measurements which is defined according to the environment and the estimated speed of movement for the mobile stations.

Based on these calculations, the station will compare the metric obtained to predetermined threshold values. These parameters (measured metric) must be determined sufficiently accurately to distinguish propagation changes (for example, a new obstacle), mainly associated with changes in the received signal strength and changes in the arrival angles which have an impact on both metrics. Thus, when the signal strength falls below a threshold value, the strength level alone should be adjusted, whereas, when both SSM and SQM metrics decrease and fall below predetermined threshold values, the blind tracking procedure must be implemented. In this case, the station or its near neighbors will move in a direction that has a component perpendicular to the direction of arrival or DOA. If the two stations A and B move along the straight line (A, B), that is to say, without any component perpendicular to the direction of arrival of the signals, or if an obstacle appears between the two nodes A, B, then the degradation of the state of the link simply requires a strength adjustment and not a change of antenna direction.

The tracking procedure proposed presents the advantage of not affecting the behavior of the network because it relies on the use of a transmission slot dedicated to the implementation of measurements. In practice, a blind procedure for managing the mobility of the nodes of the network requires measurements to be performed with different antenna beam pointing directions. Such a modification can have an impact on the synchronization if it is done when transmitting the synchronization pattern and may also cause a loss of a packet when done while transmitting.

FIG. 12 diagrammatically represents an exemplary implementation procedure for mobility management in WiMAX systems.

In this FIG. 12, two procedures are proposed, one for the subscriber stations SS or the “subscriber station” parts of the relay stations RS(SS), the other being dedicated to the base stations BS or the “base station” parts of the relay stations RS(BS).

Thus, the proposed procedure is based on the use of the periodic “ranging” procedure which is included in the WiMAX standards. “Ranging” is a procedure which enables the SS and BS stations to maintain radio communication link quality between them. The implementation of the tracking procedure in the “ranging” period does not cause disturbances to the operation of the network because the ranging messages are only associated with measurements. Consequently, the loss of one or more ranging packets during tests performed on the antenna (change of beam direction) does not result in loss of synchronization, nor in any increase in error rate on data packets.

An SS or RS(SS) waits, steps 12.0 and 12.1, initially for the ranging period in the frame, then changes, step 12.2, the direction of the beam and sends a ranging request message (RNG-REQ) 12.3 to the station of higher level. If no response to the message is received at this station, the method returns to the step 12.1. Otherwise, a response is received, step 12.5, and the node performs measurements on the message transmitted in response by the station of higher level (RNG-RSP). This procedure is carried out for one or more beams of the antenna so as to be able to compare the measurements. The resultant metrics are stored, 12.6, and if the value measured for each of the two metrics is higher than the value of the predetermined threshold levels, 12.7, then the selection of the beam is successful and the tracking procedure is finished, 12.7. Otherwise, the method tests, 12.8, to see whether all the beams have been tested. If yes, then the beam is initialized, 12.9, and if not, the method returns to the step 12.1. The initialization of the beam means that the beam associated with the best signal quality is selected and used thereafter for the operation of the relay station when the smart antenna is in directional mode. It may be that no beam is available to observe the levels required for the signal quality and signal strength and, in this case, the beam used before the procedure is selected and the tracking procedure is stopped. FIG. 13 describes the various steps executed during the procedure used by a base station BS or the “base station” part of a relay station RS(BS) is close to that implemented in the SS and RS(SS) stations. When a station initiates a tracking procedure 13.0, it waits for the next “ranging” period in the frame 13.1, then changes antenna mode to use the omnidirectional capabilities of the smart antenna. In the “ranging” period, if the station receives a message originating from a station of lower hierarchical level, the latter being identified as having to be tracked (“tracking” procedure), then it sends a response (RNG-RSP) requesting the retransmission of this message, 13.3. Then, it sets itself to directional mode using one of the directional beams and waits to receive the message concerned, 13.4. Then, in the state 13.5, the station tests to see if it is receiving the message. If the station is not receiving the message, then it sets itself to the state 13.1. Otherwise, the station performs the signal quality measurements on the received packet, 13.6, and then it changes antenna mode, 13.7, to set itself to omnidirectional operating mode and thus be able to communicate with other stations of lower level in the ranging period.

The steps 13.8, 13.9, 13.10 and 13.11 are identical to the steps 12.6, 12.7, 12.8 and 12.9 described previously.

The metrics can be measured a number of times with the same beam so as to average the values and thus obtain more stable link states. Furthermore, the selection of the beam in the above procedures is not random or performed in a “round robin” manner. It takes account of the mobility behavior that has been observed during the preceding measurements. This is based on beam indices, shown in FIG. 13.

In this FIG. 13, an index k is associated with a beam selected before the tracking procedure while the other available beams correspond to an index related to k. At the start of the tracking procedure, a scanning direction is determined, based on the stored measurements, enabling a station to be up to date with the mobility trend. All the beams that may be available according to the scanning direction will receive an index k incremented by the number of beams that separate it from the initial beam, the index including the beam concerned (k−1, k−2, etc). Thus, almost half of the beams are located in the scanning direction. In addition, a target index is identified by virtue of the stored measurements. This target index is related to the theoretical direction that would have to be used if the behavior of the network had not been modified.

The first selection of a beam is based on the target index (k+x), then, for as long as the metrics are below the predetermined threshold levels, the beam will be selected according to the criteria described hereinbelow. The station begins by selecting the adjacent beams (k+x−1) and (k+x+1) and then it tries all the beams in the scanning direction starting from the adjacent beams. If the method is still unsuccessful, then the station will test the beams that are not in the scanning direction, starting from the beam adjacent to the initial section and then by decrementing the index.

The method and the relay station according to the invention notably offer the benefits listed hereinbelow.

The development of the relay stations, being based on existing modules, requires no modification to the physical layer and only minor changes to the MAC layer. Furthermore, the proposed architecture will make it possible to significantly increase the capabilities of the network by virtue of frequency reuse (multi-channel mode). The invention also proposes mechanisms enabling the network to configure itself and organize itself in order to support a dynamic topology.

When the invention uses smart antennas, such as, for example, FESA-type antennas, the invention notably offers the following advantages:
In the multichannel mode, the use of directional antennas makes it possible to reduce interference between different adjacent channels. This makes it possible to transmit and receive simultaneously. In fixed systems, the relay station of a subscriber station can use a directional antenna. However, the use of a smart antenna allows the network to be automatically reconfigured should a link go down or a relay station be lost. In mobile systems, a smart antenna is required for the subscriber station of a relay station since the node must be capable of tracking this station. With regard to the base station of a relay station, a smart antenna, for example of FESA type, offers an inexpensive and highly effective solution by replacing the omnidirectional antennas and the conventional smart antennas that use, for example, “beam forming”.
In the single-channel operating mode, it is possible to deploy two antennas or just one antenna since the channel is time-shared between two radios or two radio modules. For the latter usage case, the use of a single directional antenna cannot be considered since the relay station RS must be capable of communicating with the base station and with a number of subscriber stations located at different points. The FESA system offers a directional beam capability while retaining an omnidirectional mode of operation by exploiting the very rapid switching of the FESA antenna.
The possibility for the base station and the relay stations to communicate with their subscriber stations with a better link budget compared to omnidirectional antennas.
The provision of an automatic relay reconfiguration capability in the event of failure or destruction of one of the relays, which does not allow for the use of fixed directional antennas.

1. A relay station RS used in a communication network that has a tree-structured architecture including a number of hierarchical levels TLi, said communication network comprising a base station BS₀, of the highest hierarchical level, one or more relay stations RSᵢ and one or more subscriber stations SSi, wherein a relay station RSₙ has at least two radio modules, a first radio module being designed to communicate with stations of lower hierarchical level TL₍ₙ₊₁₎ and a second radio module being designed to communicate with stations of higher hierarchical level TL₍ₙ₋₁₎, the two radio modules being synchronized in their MAC layer and said relay station comprising at least one antenna connected to said MAC layer of the radio modules.

2. The relay station as claimed in claim 1, wherein said relay station RSₙ comprises a single antenna and wherein a radio module includes base band physical layer, a radio frequency physical layer and an MAC layer, and wherein said relay station comprises a switch receiving radio frequency signals RF from the physical layer of each of the modules and also from the antenna, and a switch receiving the commands originating from the MAC layer and being connected to said antenna.

3. The relay station as claimed in claim 2, further comprising an RF physical layer common to both radio modules, said radio frequency physical layer being placed between the switch and the antenna.

4. The relay station as claimed in claim 1, wherein the frame having the information or data to be transmitted includes two parts corresponding to a reception period RX and a transmission period TX, and wherein the transmission sequence is as follows:
in the period RX, corresponding to the time slot T₁, the subscriber station part of the relay station RSₙ(SS) receives a data stream F₁ transmitted by the higher level station (downward stream), BSₙ₋₁ or RSₙ₋₁(BS), and the base station part of this relay station RSₙ(BS) receives a data stream F₂ originating from one or more subscriber stations SSₙ₊₁ or RSₙ₊₁(SS) of lower hierarchical level (upward stream),
in the period TX, corresponding to the time slot T₂, the subscriber station part of the relay station RSₙ(SS) transmits data F₃ to the higher level station (upward stream), BSₙ₋₁or RSₙ₋₁(BS), and the base station part of this relay station RSₙ(BS) transmits data F₄ to one or more stations of lower hierarchical level (downward stream).

5. The relay station as claimed in claim 1, wherein the frame having the information or data to be transmitted includes two parts corresponding to a reception period RX and a transmission period TX, and wherein the transmission sequence is as follows:
in the first period RX (time slot T₃), the SS part of the relay station RSₙ(SS) receives a data stream F₅ from the higher level station, and during this time, the BS part of the relay station RSₙ(BS) is idle,
in the first period TX, corresponding to the time slot T₄, the BS part of the relay station RSₙ(BS) transmits a data stream F₆ to one or more lower level stations, then a TX/RX switchover enables the same part, RSₙ(BS), to receive a data stream F₇ transmitted from the lower hierarchical level,
in the second period TX, time slot T₆, the SS part of RSₙ transmits a data stream F₈ to the higher level station BSₙ₊₁ or RSₙ₊₁(BS).

6. The relay station as claimed in claim 1, wherein the frame having the information or data to be transmitted includes two parts corresponding to a reception period RX and a transmission period TX, and wherein the transmission sequence is as follows:
in the first period RX, time slot T₇, the SS part of the relay station RSₙ(SS) receives a data stream F₉ from the station of higher level n+1, and during this time, the BS part of the relay station RSₙ(BS) is idle,
in the first part of the period TX, time slot T₈, the BS part of the relay station RSₙ(BS) transmits a data stream F₁₀ to the station of higher level n+1, then a TX/RX switchover enables the SS part of the relay station RSₙ(SS) to transmit in the time slot T₉ of the period TX to one or more stations of lower hierarchical level n−1, then this same part will receive in the time slot T₁₀ of the period RX a data stream F₁₂ originating from one or more stations of lower hierarchical level n−1.

7. The relay station as claimed in claim 6, wherein the frame in a branch allows for simultaneous transmissions in the level n and n+2, namely, for example, between BSₙ₊₂ and SSₙ₊₃on the one hand and BSₙ and SSₙ₊₁on the other hand.

8. The relay station as claimed in claim 1, wherein the synchronization is performed by transmitting a synchronization pattern Ts from the subscriber station part RSₙ(SS) to the base station part RSn(BS) at the end of the first period RX.

9. The relay station as claimed in claim 1, wherein the relay of the data, control and management packets is performed at level two of the OSI protocol stack by establishing a link between the two MAC layers of the two radio modules of this same station.

10. The relay station as claimed in claim 1, wherein the antenna with which said relay station is equipped is a fast-switching smart antenna, of FESA type.

11. A transmission method implemented within a relay station as claimed in claim 1, wherein it uses a smart antenna and in that said smart antenna uses an omnidirectional mode in the periods of the frame in which the relay station transmits in broadcast mode to the lower hierarchical level or in which the relay station receives messages transmitted in a contention period, said messages transmitted in these two periods of the frame using a robust modulation such as QPSK modulation whereas the other transmission slots use modulations designed to offer a higher bit rate.

12. A method implemented within a relay station as claimed in claim 1, wherein it uses a smart antenna and in that it comprises a step during which the changes of direction of the beam from the smart antenna, enabling the directions of arrival of the messages at a given moment to be assessed, occur in a period of the frame dedicated to the procedures used to assess the distance between two stations of different hierarchical levels and the associated so-called ranging transmission powers by the exchange of existing ranging messages and measurement of at least one of the received signal strength and the packet error ratio.
